(19) United States
(12) Patent Application Publication
(10) Pub. No.: US 2013/0042623 A1
(43) Pub. Date: Feb. 21, 2013

(54) CONICAL REVERSE-FLOW COMBUSTION CHAMBER FOR A TURBOMACHINE

(71) Applicant: Denis Jean Maurice SANDELIS, Nangis (FR)

(72) Inventor: Denis Jean Maurice SANDELIS, Nangis (FR)

(73) Assignee: SNECMA, Paris (FR)

(21) Appl. No.: 13/561,218

(22) Filed: Jul. 30, 2012

(30) Foreign Application Priority Data
Aug. 16, 2011 (FR) 11 57354

(51) Int. Cl. F02C 3/14; F23R 3/00

(52) U.S. Cl. 60/751

(57) ABSTRACT

Assembly consisting of a reverse-flow combustion chamber for a turbomachine and a diffuser intended to be positioned at the outlet of a centrifugal compressor and comprising two faces running parallel to one another, the said combustion chamber comprising a first annular part configured to bear at least one injection system and a second annular part extending beyond this first part so as to form a guide canal for turning back the direction in which the gases passing through the chamber flow, with reference to the axis of rotation of the said turbomachine, the axis Y-Y of the said first part being secant with the said axis of rotation, the assembly being characterized in that the said faces of the diffuser have a curved shape which evolves parallel to that of the outer wall of the chamber at its turn-back canal.

The field of the present invention is that of turbomachines and more particularly of aeronautical turbojet engines or turbine engines.

Turbomachines conventionally comprise one or more compressors, an annular combustion chamber surrounding one or more drive shafts and one or more turbines which drive the compressor or compressors via the drive shaft or shafts. The compressors used may be of two types, axial compressors in which the direction of the inlet and the direction of the outlet of the air that is to be compressed are aligned with the axis of rotation of the engine, and centrifugal compressors in which the direction of the air inlet is aligned with the axis of rotation but in which the direction of the outlet is radial, i.e. perpendicular to this axis.

In the remainder of the description, the terms axial or radial relate to the axis of rotation of the turbomachine, the terms upstream and downstream relate to the direction in which the gases flow through the turbomachine, and finally, the terms exterior/outside or interior/inside correspond to greater or lesser radial separation from this axis. Moreover, the terms axis or direction when applied to the combustion chamber alone denote the direction of the central axis of the cross section of this chamber on a half-plane passing through the axis of rotation of the turbomachine. The terms cylindrical chamber or conical chamber thus indicate that the direction of the central axis of this section of the chamber is either parallel to or secant with the axis of rotation of the turbomachine.

The present invention relates to turbomachines that have a compressor the final stage of which is centrifugal. It is therefore necessary to straighten the stream of air leaving this compressor in order to bring it into the direction of the inlet to the combustion chamber. This straightening is generally performed by an annular diffuser which is oriented first of all radially along the axis of the outlet of the centrifugal compressor and then has an elbow to convey the air in a direction oriented substantially towards the combustion chamber.

As is commonplace in these turbomachines, the direction in which the gases flow in the combustion chamber is oriented either towards the front of the engine (in which case the chamber is said to be of the reverse-flow type) or towards the rear (in which case the chamber is said to be of the straight-through type). The diffuser outlet in the former instance is oriented along the axis of the engine and placed on the outside, above the combustion chamber, and in the latter instance as described in the applicant company's patent application FR2920032, it is oriented toward the inlet of the combustion chamber secant with the axis of the engine.

In the case of straight-through chambers, the designers of turbomachines have generally positioned an elbow at the diffuser outlet and oriented these chambers in such a way that their axis is inclined in the direction of the axis of rotation of the engine. This configuration, which creates a succession of diffuser followed by chamber along the axis of rotation of the turbomachine, has the disadvantage of leaving a stagnant region upstream of the combustion chamber, which corresponds to the axial length of the elbowed part of the diffuser. This has the effect of increasing the axial length of the machine and therefore increasing its mass. Moreover, the choice of a cylindrical straight-through combustion chamber to be positioned under the outlet of the diffuser would have the disadvantage of moving the point of exit from the diffuser radially away from the point of inlet of air to the chamber and of creating a risk of increased pressure drops between the outlet of the diffuser and the inlet to the chamber. It would also require a larger diameter for the diffuser, and this would increase the overall mass of the engine.

This disadvantage does not exist in the case of reverse-flow chambers as the diffuser can be positioned above the combustion chamber at the start of its turn-back. There is therefore no succession of diffuser and chamber along the axis of the engine and the axial length can therefore be shorter than it can for a conical straight-through chamber. However, for industrial production reasons, it is simpler to choose a combustion chamber with an axis oriented along the axis of the engine and to give this chamber a cylindrical shape. This is therefore the configuration systematically adopted for reverse-flow chambers in the prior art.

However, this configuration forces the air to follow an S-shaped path, with two turn-backs at 180° one between the outlet of the diffuser and the inlet to the combustion chamber and a second within the chamber. The first 180° turn-back requires a certain length in order to avoid pressure drops. Once again, the axial length of the machine and, therefore, its mass, are not optimal. Moreover, steps have to be taken to ensure that the outlet section of the diffuser is as large as possible, in order to reduce the Mach number of the exiting flow and thus improve the thermodynamic efficiency of the turbomachine.

It is an object of the present invention to address these disadvantages by providing a turbomachine combustion chamber configuration that has no stagnant region in its environment, that allows the turbomachine to be given a minimum axial length and that offers a maximum outlet section for the diffuser.

To this end, one subject of the invention is an assembly consisting of a reverse-flow combustion chamber for a turbomachine and a diffuser intended to be positioned at the outlet of a centrifugal compressor and comprising two faces running parallel to one another, the said combustion chamber comprising a first annular part configured to bear at least one injection system and a second annular part extending beyond this first part so as to form a guide canal for turning back the direction in which the gases passing through the chamber flow, with reference to the axis of rotation of the said turbomachine, the axis Y-Y of the said first part being secant with the said axis of rotation, the assembly being characterized in that the said faces of the diffuser have a curved shape which evolves parallel to that of the outer wall of the chamber at its turn-back canal.

The act of positioning the first part of a reverse-flow chamber obliquely makes it possible first of all to shorten its axial length, measured along its axis of symmetry, and secondly to make it easier to house underneath a centrifugal compressor diffuser. This configuration then makes it possible to reduce the axial extension of the diffuser and therefore reduce the overall mass of the engine. Finally, the overall bulk of the two elements and, therefore, their radial extension and, as a result, the overall mass of the engine, are optimized. Moreover, the outward radial extension of the diffuser increases its outlet section and therefore reduces the Mach number of the exiting flow, and this is beneficial in terms of the overall thermodynamic efficiency of the turbomachine.

Advantageously, the axis of the second part of the chamber at the gas outlet, is aligned with the orientation of the said axis of rotation, the said first part being positioned on the outside of the said second part. This then yields a configuration that is relatively compact and remains compatible with positioning the chamber underneath a centrifugal compressor diffuser.

For preference, the axis Y-Y of the first part of the chamber makes an angle of between 30 and 60° with the direction of the axis of the second part at the gas outlet. This angle makes it possible to optimize the flow of air exiting a diffuser and makes it easier to turn back before it enters the chamber.

Advantageously, the direction in which the air flows between the walls of the diffuser evolves between a radial orientation at the inlet orifice and an orientation at the outlet orifice which makes an angle of less than 90° with the direction of the axis of rotation.

This configuration also makes it easier to position the chamber underneath this diffuser.

For preference, the orientation of the walls of the diffuser at its outlet orifice is parallel to the said axis Y-Y of the first part of the chamber. This configuration is beneficial to the flow of air between its leaving the diffuser and its entering the combustion chamber, by reproducing the known design from cylindrical reverse-flow combustion chambers.

In one particular embodiment, the walls of the diffuser and the external wall of the chamber at its turn-back channel have concentric toric shapes.

For preference, the diffuser has just one single one-piece flow straightener along the path followed by the air leaving the compressor. This single flow-straightener configuration has better aerodynamic effectiveness than the disjointed flow straighteners of the prior art.

The invention finally relates to a turbomachine equipped with a centrifugal compressor for its final compression stage, which is characterized in that it comprises an assembly like those described hereinabove at the outlet of the said compressor.

The invention will be better understood, and other objects, details, features and advantages thereof will become more clearly apparent during the course of the detailed explanatory description which follows of one embodiment of the invention given purely by way of nonlimiting illustration with reference to the attached schematic drawings.

In these drawings:

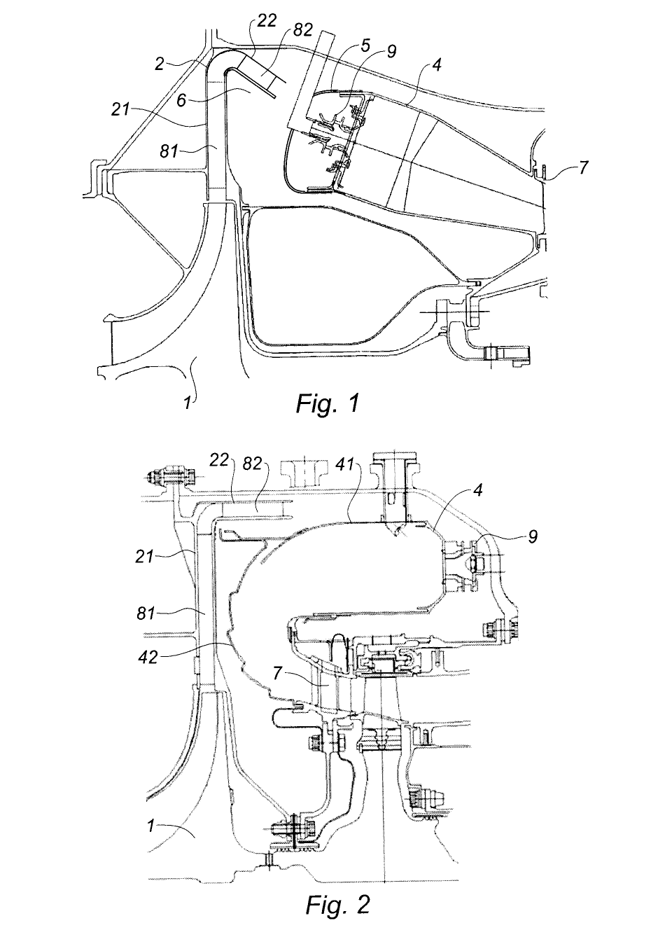

FIG. 1 is a view in cross section of a straight-through combustion chamber according to the prior art;

FIG. 2 is a view in cross section of a reverse-flow combustion chamber according to the prior art;

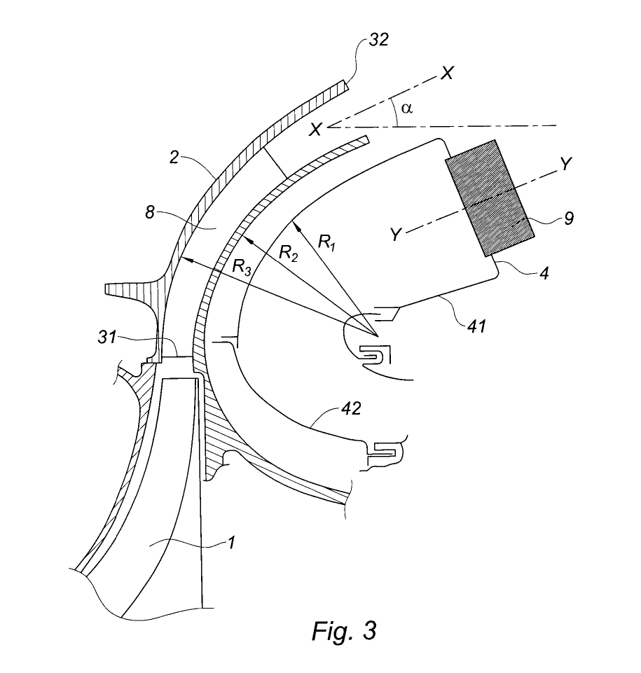

FIG. 3 is a view in cross section of a reverse-flow combustion chamber and of a diffuser configured according to one embodiment of the invention.

Reference is made to FIG. 1 which shows the part of a turbomachine of the prior art equipped with a centrifugal compressor, which is situated between the outlet of the compressor 1 and the inlet to the turbine nozzle 7. The centrifugal compressor 1, which is in the form of a wheel, compresses the air and ejects it radially into a fixed annular diffuser 2, of which a first part 21, likewise oriented radially, ends in an elbow and is then continued by a second part 22 that is inclined and oriented in the direction of the combustion chamber 4. The air thus leaves the diffuser 2 and enters the combustion chamber 4, which is of the straight-through type, with no significant variation in its direction of travel. In order to channel the air inside the diffuser 2 and eliminate the tangential component of its direction, the diffuser is fitted with flow straighteners 81 and 82 which have the form of walls oriented substantially in an axial plane and which extend between its upstream and downstream faces. A first flow straightener 81 is positioned in the radial first part 21 of the diffuser while the second flow straightener 82 is positioned in the inclined second part 22 thereof.

The chamber 4 has a conical angular shape, which means to say that its axis is secant with the axis of the turbomachine. Bearing in mind the elbow that the diffuser has to create in order to straighten the air and send it towards the combustion chamber, the radius at is outlet plane is limited and, as a result of this, the outlet section of the diffuser cannot be increased as much as might be desired unless its walls are made to diverge gradually from one another. It then follows that, in the case of a diffuser with parallel walls, the speed of the air leaving the diffuser is still high (of the order of Mach 0.2) and that leads to pressure drops that are not inconsiderable and require the fitting of fairings 5 to surround the injection system 9 in the region of the inlet to the chamber 4.

The configuration illustrated therefore has numerous disadvantages, such as the need for the fairings 5 and the presence of a stagnant region 6, which is of no practical benefit and which needlessly lengthens the axial length of the engine and, therefore, increases its mass.

FIG. 2 shows another configuration of a turbomachine of the prior art, in which the chamber 4 this time is positioned the other way around. As previously, air from the centrifugal compressor 1 emerges into a diffuser 2 the first part 21 of which is radial but of which the second part 22 here is oriented axially. This diffuser also comprises two flow straighteners, a first flow straightener 81 in its radial part 21 and a second 82 in its axial part 22. The combustion chamber 4, of annular shape, comprises a first cylindrical part 41, which bears the injection system 9, which is coaxial with the axis of rotation of the turbomachine and which continues with a turn-back 42 to bring the gases into the axial direction and send them on to the turbine nozzle 7 in their conventional direction of flow. The axial orientation of the second part 22 of the diffuser 2, combined with the presence of the turn-back 42, makes it possible to free up some space underneath this second part of the diffuser and thus offers some space for the combustion chamber 4, which can be shifted further towards the upstream end of the engine until it lies a very short distance from the downstream face of the wheel of the centrifugal compressor 1. The air from the diffuser also is at a relatively low speed (with a Mach number typically of between 0.14 to 0.16) because the outlet from the diffuser is at the external wall surrounding the chamber, i.e. at a radius that is as high as possible. The outlet section of the diffuser is thus as great as it can be, for a given thickness of the diffuser flow path.

The path that the air takes between leaving the second part 22 of the diffuser and leaving the chamber 4, at the inlet to the turbine nozzle 7 is, on the other hand, relatively long because it consists of two turn-backs through 180°.

An embodiment of the invention will now be described with reference to FIG. 3. Elements identical to the embodiments of the prior art are denoted by the same reference numeral and not described again.

Here, the combustion chamber 4 is the other way around, but unlike the combustion chamber of FIG. 2 is not cylindrical in shape. Its first part 41 is said to be conical because it has the form of an annulus surrounding the walls, of a cone the vertex of which is situated towards the upstream side of the turbomachine. The axis Y-Y of the first part of the chamber diverges from the direction of the axis of rotation of the turbomachine. The magnitude a of the angle between the two directions is in a range typically from 30 to 60°, without these values constituting extrema that restrict the scope of the invention. The second part of the chamber, i.e. the turnback 42, is similar to that of the previous scenario except that it is shorter, because the amount of deflection it needs to provide is smaller, by a value α, than the 180° of turn-back in the previous scenario.

This reverse-flow combustion chamber is, once again, positioned as far upstream as possible, i.e. at a minimum distance from the downstream face of the wheel of the centrifugal compressor 1 and from that of the diffuser 2, which distance is still compatible with the various movements of the components being used. By contrast, the shape of the diffuser 2 is very different from the prior art because it has a curved shape parallel to the external wall of the chamber 4. Its inlet orifice 31 is positioned opposite the outlet of the wheel of the compressor 1, with an axis which is oriented radially, whereas the axis of its outlet orifice 32 is oriented in a direction X-X that is inclined with respect to the axis of rotation of the turbomachine. As depicted in the figure this axis X-X is parallel to that Y-Y of the first part 41 of the combustion chamber and therefore makes an angle α with the axis of rotation, without this identicalness of the angles of inclination being essential to embodying the invention. In any event, the angle that the direction X-X makes with the axis of rotation is less than 90°, leaving the desired space for positioning the combustion chamber as far forward as possible, while at the same time remaining under the diffuser.

Whereas the external wall of the combustion chamber is substantially toric, of radius R1, at its turnback 42, the upstream and downstream walls of the diffuser 2 are also toric, with radii R3 and R2 respectively, the three toruses being concentric.

Because the diffuser 2 has a continuous shape and no pronounced elbow, it is possible to fit just one flow straightener 8 between its two walls, and to have this extend over sufficient length to eliminate the tangential component from the flow leaving the compressor 1. Thus, with this reduction from two flow straightening elements to just one, the production of the diffuser 2 is simplified and greater aerodynamic effectiveness at eliminating the tangential component is afforded.

The various advantages afforded by the invention can be summarized as follows: because the first part 41 of the chamber is positioned at an angle to the axis of rotation of the turbomachine, its axial extension is reduced, substantially in a proportion equal to cos α. This reduction automatically leads to reductions in the various casings or case that constitute the combustion chamber module and therefore reduces the overall mass of the engine.

The second part 42 of this same chamber turns the flow back through only an angle less than 180° and is therefore, measured in a curved line, shorter than the turn-back of a conventional cylindrical reverse-flow chamber. Once again, this configuration tends towards reducing the overall mass of the engine.

Because the diffuser is curved and substantially parallel to the external wall of the chamber its length can be extended as much as desired. There is nothing to prevent its being extended as far as the outer casing that envelops the chamber, in order to obtain an outlet area 32 which is as large as possible. This then reduces the Mach number of the flow leaving the diffuser, which number can then be reduced to values of between 0.10 and 0.15. This reduction is beneficial to reducing pressure drops and contributes to improving the thermodynamic efficiency of the turbomachine.

Likewise, reducing the second turnback experienced by the path of the air between the outlet 32 from the diffuser and the inlet to the turbine nozzle 7 to less than 180° once again makes it possible to reduce the pressure drops experienced as it passes through the combustion chamber module.

Finally, creating a diffuser 2 that has just one flow straightener 8 makes it possible to simplify the manufacture thereof. A single flow straightener 8 is moreover, because of the continuity of its action, better able to eliminate the tangential component than the two disjointed flow straighteners 81 and 82 of the prior art. It improved effectiveness then allows its length to be reduced for the same effectiveness, and therefore allows a reduction in mass or alternatively allows an increase in effectiveness for the same overall length in order to improve the efficiency of the turbomachine.

1. Assembly consisting of a reverse-flow combustion chamber for a turbomachine and a diffuser intended to be positioned at the outlet of a centrifugal compressor and comprising two faces running parallel to one another, the said combustion chamber comprising a first annular part configured to bear at least one injection system and a second annular part extending beyond this first part so as to form a guide canal for turning back the direction in which the gases passing through the chamber flow, with reference to the axis of rotation of the said turbomachine, the axis Y-Y of the said first part being secant with the said axis of rotation, the assembly being characterized in that the said faces of the diffuser have a curved shape which evolves parallel to that of the outer wall of the chamber at its turn-back canal.

2. Assembly according to claim 1, in which the axis of the second part of the chamber at the gas outlet, is aligned with the orientation of the said axis of rotation, the said first part being positioned on the outside of the said second part.

3. Assembly according to claim 1 in which the axis Y-Y of the first part of the chamber makes an angle of between 30 and 60° with the direction of the axis of the second part at the gas outlet.

4. Assembly according to claim 1 in which the direction in which the air flows between the walls of the diffuser evolves between a radial orientation at the inlet orifice and an orientation at the outlet orifice which makes an angle of less than 90° with the direction of the axis of rotation.

5. Assembly according to claim 4 in which the orientation of the walls of the diffuser at its outlet orifice is parallel to the said axis Y-Y of the first part of the chamber.

6. Assembly according to claim 1 in which the walls of the diffuser and the external wall of the chamber at its turn-back channel have concentric toric shapes.

7. Assembly according to claim 1 in which the diffuser has just one single one-piece flow straightener along the path followed by the air leaving the compressor.

8. Turbomachine equipped with a centrifugal compressor for its final compression stage, characterized in that it comprises an assembly according to claim 1 at the outlet of the said compressor.
